(19) United States
(12) Patent Application Publication
(10) Pub. No.: US 2014/0244273 A1
(43) Pub. Date: Aug. 28, 2014

(54) VOICE-CONTROLLED COMMUNICATION CONNECTIONS

(71) Applicants: Jean Laroche, Santa Cruz, CA (US); David P. Rossum, Santa Cruz, CA (US)

(72) Inventors: Jean Laroche, Santa Cruz, CA (US); David P. Rossum, Santa Cruz, CA (US)

(21) Appl. No.: 14/191,241

(22) Filed: Feb. 26, 2014

Related U.S. Application Data
(60) Provisional application No. 61/770,264, filed on Feb. 27, 2013.

(51) Int. Cl. G06F 3/16; G10L 15/22

(52) U.S. Cl. CPC G06F 3/167; G10L 15/22
USPC 704/275

(57) ABSTRACT

Systems and methods for voice-controlled communication connections are provided. An example system includes a mobile device being operated consecutively in listen, wakeup, authentication, and connect modes. Each of subsequent modes consumes more power than a preceding mode. The listen mode consumes less than 5 mW. In the listen mode, the mobile device listens for an acoustic signal, determines whether the acoustic signal includes voice, and upon the determination, selectively enters the wakeup mode. In the wakeup mode, the mobile device determines whether the acoustic signal includes a spoken word and, upon the determination, enters the authentication mode. In authentication mode, the mobile device identifies a user using the spoken command and, upon the identification, enters the connect mode. In the connect mode, the mobile device receives an acoustic signal, determines whether the acoustic signal includes a spoken command and performs one or more operations associated with the spoken command.

### CROSS-REFERENCE TO RELATED APPLICATION

The present application claims the benefit of the U.S. Provisional Application No. 61/770,264, filed on Feb. 27, 2013. The subject matter of the aforementioned application is incorporated herein by reference for all purposes.

### FIELD

The present application relates generally to audio processing and more specifically to systems and methods for voice-controlled communication connections.

### BACKGROUND

Control of mobile devices can be difficult due to limitations posed by user interfaces. On one hand, fewer buttons or selections on the mobile device can make the mobile device easier to operate but can offer less control and/or make control unwieldy. On the other hand, too many buttons or selections can make the mobile device harder to handle. Some user interfaces may require navigating a multitude of options or selections in its menus to perform (even routine) tasks. In addition, some operating environments may not permit a user to pay full attention to a user interface, for example, while operating a vehicle.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an example embodiment, a method for voice-controlled communication connections comprises operating a mobile device in a several operating modes. In some embodiments, the operating modes may include a listen mode, a voice wakeup mode, an authentication mode, and a carrier connect mode. In some embodiments, modes used earlier can consume less power than modes used later, with the listen mode consuming the least power. In various embodiments, each successive mode can consume more power than the preceding mode, with the listen mode consuming the least power.

In some embodiments, while operating in the listen mode, with the mobile device on, the power consumption is no more than 5 mW. The mobile device can continue to operate in the listen mode until an acoustic signal is received by one or more microphones of the mobile device. In some embodiments, the mobile device can be operable to determine whether the received acoustic signal is a voice. The received acoustic signal can be stored in the memory of the mobile device.

After receiving the acoustic signal, the mobile device can enter the wakeup mode. While operating in the wakeup mode, the mobile device is configured to determine whether the acoustic signal includes one or more spoken commands. Upon the determination of a presence of one or more spoken commands in the acoustic signal, the mobile device enters the authentication mode.

While operating in authentication mode, the mobile device can determine the identity of a user using spoken commands. Once user's identity has been determined, the mobile device enters the connect mode. While operating in connect mode, the mobile device is configured to perform operations associated with the spoken command(s) and/or a subsequently spoken command(s).

Acoustic signal(s) which may contain at least one of the spoken command and subsequently spoken command may be recorded or buffered, processed to suppress and/or cancel noise (e.g., for noise robustness), and/or be processed for automatic speech recognition.

### BRIEF DESCRIPTION OF THE DRAWINGS

Embodiments are illustrated by way of example and not limitation in the figures of the accompanying drawings, in which like references indicate similar elements and in which:

FIG. 1 is an example environment wherein a method for voice-controlled communication connections can be practiced.

FIG. 2 is a block diagram of a mobile device that can implement a method for voice-controlled communication connections, according to an example embodiment.

FIG. 3 is a block diagram showing components of a system for voice-controlled communication connections, according to an example embodiment.

FIG. 4 is a block diagram showing modes of a system for voice-controlled communication connections, according to an example embodiment.

FIGS. 5-9 are flowcharts showing steps of methods for voice-controlled communication connections, according to example embodiments.

FIG. 10 is a block diagram of a computing system implementing a method for voice-controlled communication connections, according to an example embodiment.

### DETAILED DESCRIPTION

The present disclosure provides example systems and methods for voice-controlled communication connections. Embodiments of the present disclosure can be practiced on any mobile device. Mobile devices can include: radio frequency (RF) receivers, transmitters, and transceivers; wired and/or wireless telecommunications and/or networking devices; amplifiers; audio and/or video players; encoders; decoders; speakers; inputs; outputs; storage devices; user input devices. Mobile devices may include input devices such as buttons, switches, keys, keyboards, trackballs, sliders, touch screens, one or more microphones, gyroscopes, accelerometers, global positioning system (GPS) receivers, and the like. Mobile devices may include outputs, such as LED indicators, video displays, touchscreens, speakers, and the like. In some embodiments, mobile devices may be hand-held devices, such as wired and/or wireless remote controls, notebook computers, tablet computers, phablets, smart phones, personal digital assistants, media players, mobile telephones, and the like.

Mobile devices may be used in stationary and mobile environments. Stationary environments may include residencies and commercial buildings or structures. Stationary environments can include living rooms, bedrooms, home theaters, conference rooms, auditoriums, and the like. For mobile environments, the mobile devices may be moving with a vehicle, carried by a user, or be otherwise transportable.

According to an example embodiment, a method for voice-controlled communication connections includes detecting, via the one or more microphones, an acoustic signal while the mobile device is operated in a first mode. The method can further include determining whether the acoustic signal is a voice. The method can further include switching the mobile device to a second mode based on the determination and storing the acoustic signal to a buffer. The method can further include operating the mobile device in the second mode and, while operating the mobile device in the second mode, receiving the acoustic signal, determining whether the acoustic signal includes one or more spoken commands, and, in response to determining, switching the mobile device to a third mode. The method can further include operating the mobile device in the third mode and, while operating the mobile device in the third mode, receiving the one or more spoken commands, identifying, based on the one or more spoken commands, a user, and in response to the identifying, switching the mobile device to a fourth mode. The method can further include operating the mobile device in a fourth mode and while operating the mobile device in the fourth mode receiving a further acoustic signal, determining whether the further acoustic signal is one or more further spoken command and, in response to the determination, selectively performing an operation of the mobile device, the operation corresponding to the one or more further spoken commands. While operating the mobile device in the first mode, the mobile device consumes less power than while the mobile device is being operated in the second mode. While operating in the second mode, the mobile device consumes less power than while operating in the third mode. While operating in the third mode, the mobile device consumes less power than while operating in the fourth mode.

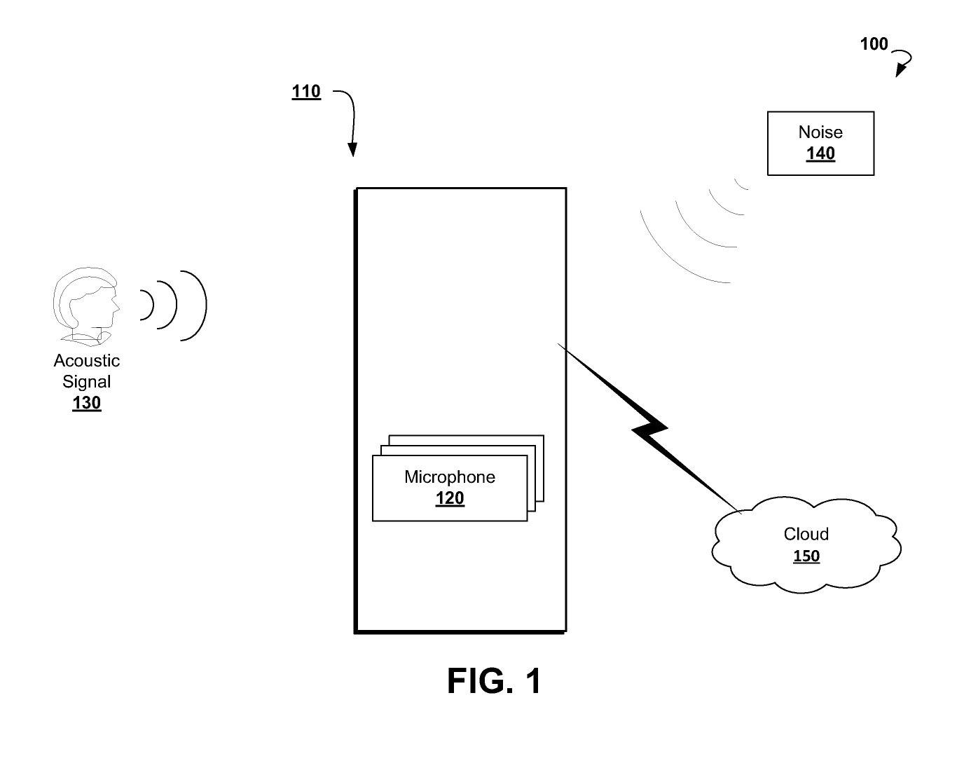

Referring now to FIG. 1, an environment 100 is shown in which a method for voice-controlled communication connections can be practiced. In example environment 100, a mobile device 110 is operable at least to receive an acoustic audio signal via one or more microphones 120 and process and/or record/store the received audio signal. In some embodiments, the mobile device 110 can be connected to a cloud 150 via a network in order for the mobile device 110 to send and receive data such as, for example, a recorded audio signal, as well as request computing services and receive back the result of the computation.

The acoustic audio signal can include at least an acoustic sound 130, for example speech of a person who operates the mobile device 110. The acoustic sound 130 can be contaminated by a noise 140. Noise sources may include street noise, ambient noise, sound from the mobile device such as audio, speech from entities other than an intended speaker(s), and the like.

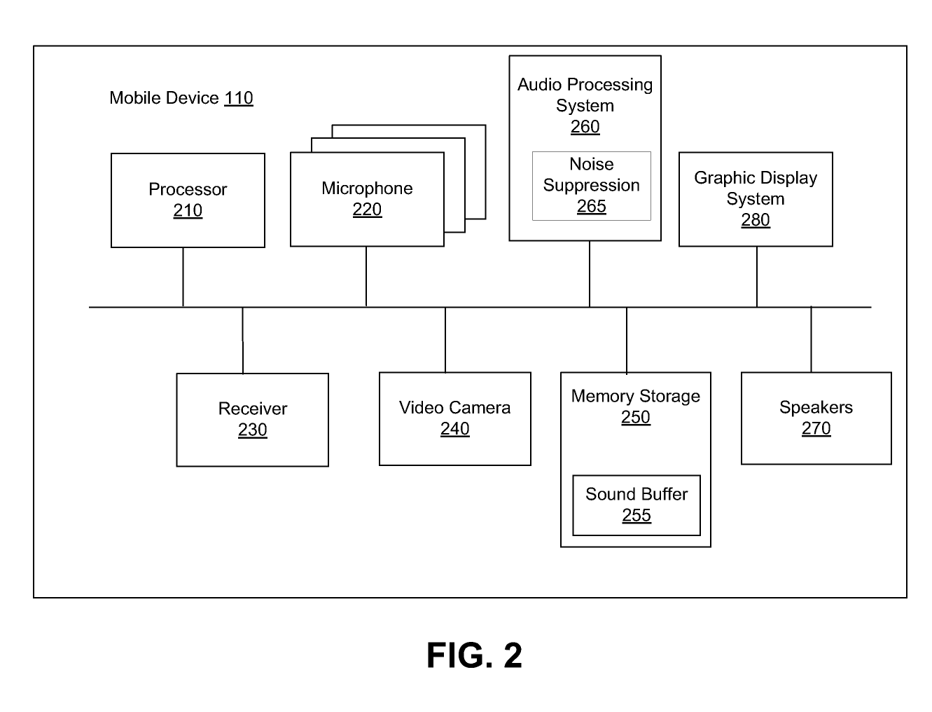

FIG. 2 is a block diagram showing components of the mobile device 110, according to an example embodiment. In the illustrated embodiment, the mobile device 110 includes a processor 210, one or more microphones 220, a receiver 230, memory storage 250, an audio processing system 260, speakers 270, graphic display system 280, and optional video camera 240. The mobile device 110 may include additional or other components necessary for operations of mobile device 110. Similarly, the mobile device 110 may include fewer components that perform functions similar or equivalent to those depicted in FIG. 2.

The processor 210 may include hardware and/or software, which is operable to execute computer programs stored in a memory storage 250. The processor 210 may use floating point operations, complex operations, and other operations, including voice-controlled communication connections.

In some embodiment, memory storage 250 may include a sound buffer 255. In other embodiments, the sound buffer 255 can be placed on a chip separate from the memory storage 250.

The graphic display system 280, in addition to playing back video, can be configured to provide a user graphic interface. In some embodiments, a touch screen associated with the graphic display system can be utilized to receive an input from a user. The options can be provided to a user via an icon or text buttons once the user touches the screen.

The audio processing system 260 can be configured to receive acoustic signals from an acoustic source via one or more microphones 220 and process acoustic signal components. The microphones 220 can be spaced a distance apart such that the acoustic waves impinging on the device from certain directions exhibit different energy levels at the two or more microphones. After reception by the microphones 220, the acoustic signals can be converted into electric signals. These electric signals can, in turn, be converted by an analog-to-digital converter (not shown) into digital signals for processing in accordance with some embodiments.

In various embodiments, where the microphones 220 are omni-directional microphones that are closely spaced (e.g., 1-2 cm apart), a beamforming technique can be used to simulate a forward-facing and backward-facing directional microphone response. A level difference can be obtained using the simulated forward-facing and backward-facing directional microphone. The level difference can be used to discriminate speech and noise in, for example, the time-frequency domain, which can be used in noise and/or echo reduction. In some embodiments, some microphones are used mainly to detect speech and other microphones are used mainly to detect noise. In various embodiments, some microphones are used to detect both noise and speech.

In some embodiments, in order to suppress the noise, an audio processing system 260 may include a noise suppression module 265. The noise suppression can be carried out by the audio processing system 260 and noise suppression module 265 of the mobile device 110 based on inter-microphone level difference, level salience, pitch salience, signal type classification, speaker identification, and so forth. An example audio processing system suitable for performing noise reduction is discussed in more detail in U.S. patent application Ser. No. 12/832,901, titled “Method for Jointly Optimizing Noise Reduction and Voice Quality in a Mono or Multi-Microphone System”, filed on Jul. 8, 2010, the disclosure of which is incorporated herein by reference for all purposes.

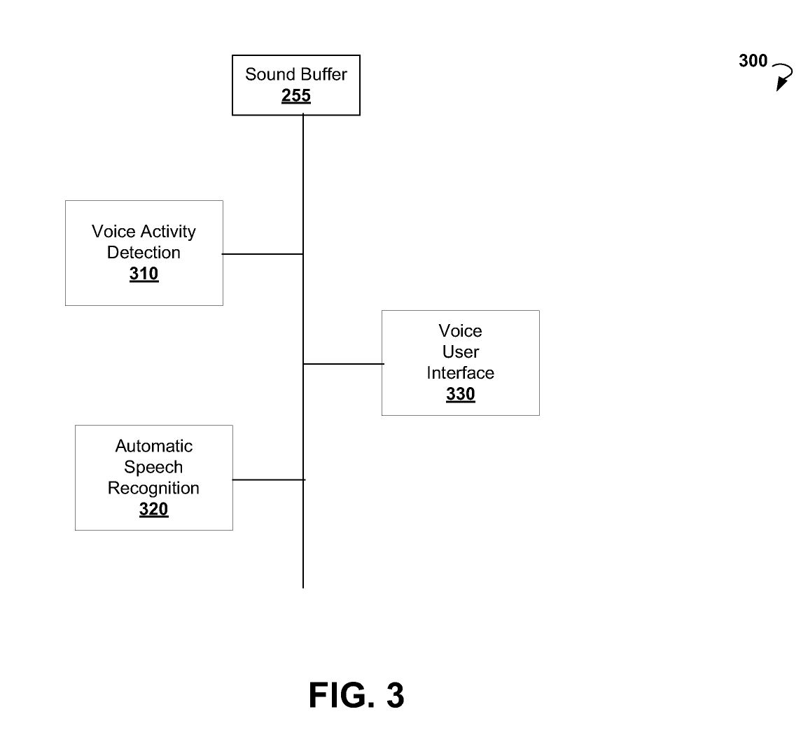

FIG. 3 shows components of a system for voice-controlled communication connections 300. In some embodiments, the components of the system for voice-controlled communications can include a voice activity detection (VAD) module 310, an automatic speech recognition (ASR) module 320, and a voice user interface (VUI) module 330. The VAD module 310, the ASR module 320, and VUI module 330 can be configured to receive and analyze acoustic signals (e.g. in digital form) stored in sound buffer 255. In some embodiments, VAD module 310, ASR module 320, and VUI module 330 can receive acoustic signal processed by audio processing system 260 (shown in FIG. 2). In some embodiments, a noise in acoustic signal can be suppressed via a noise reduction module 265.

In certain embodiments VAD, ASR, and VUI modules can be implemented as instructions stored in memory storage 250 of mobile device 110 and executed by processor 210 (shown in FIG. 2). In other embodiments, one or more of VAD, ASR, and VUI modules can be implemented as separate firmware microchips installed in mobile device 110. In some embodiments, one or more of VAD, ASR, and VUI modules can be integrated in audio processing system 260.

In some embodiments, ASR can include translations of spoken words into text or other language representations. ASR can be performed locally on the mobile device 110 or in the cloud 150 (shown in FIG. 1). The cloud 150 may include computing resources, both hardware and software, that deliver one or more services over a network, for example, the Internet, mobile phone (cell phone) network, and the like.

In some embodiments, the mobile device 110 can be controlled and/or activated in response to a certain recognized audio signal, for example, a recognized voice command including, but not limited to, one or more keywords, key phrases, and the like. The associated keywords and other voice commands are selected by a user or pre-programmed. In various embodiments, VUI module 330 can be used, for example, to perform hands-free, frequently used, and/or important communication tasks.

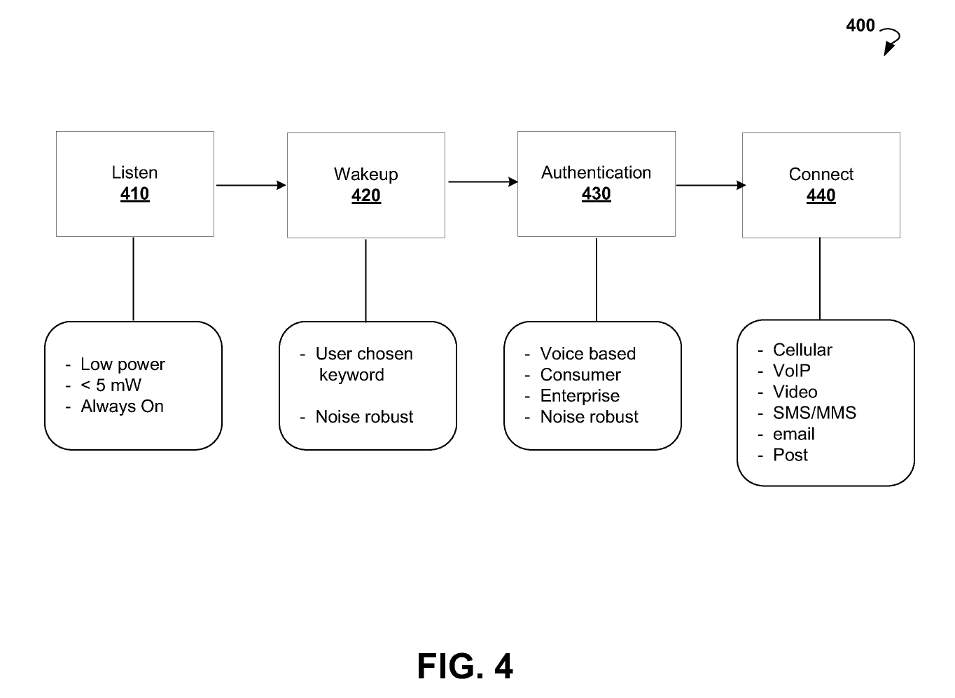

FIG. 4 illustrates modes 400 for operating mobile device 110, according to an example embodiment. Embodiments can include a low-power listen mode 410 (also referred to as “sleep” mode), a wakeup mode 420 (for example, from “sleep” mode or listen mode), authentication mode 430, and connect mode 440. In some embodiments, modes performed earlier consume less power than modes performed later, with the listen mode consuming the least power in order to conserve power. In various embodiments, each successive mode consumes more power than the preceding mode, with the listen mode consuming the least power.

In some embodiments, the mobile device 110 is configured to operate in a listen mode 410. In operation, the listen mode 410 consumes low power (for example, less than 5 mW). In some embodiments, the listen mode continues, for example, until an acoustic signal is received. The acoustic signal may, for example, be received by one or more microphones in the mobile device. One or more stages of voice activity detection (VAD) can be used. The received acoustic signal can be stored or buffered in a memory before or after the one or more stages of VAD are used based on power constraints. In various embodiments, the listen mode continues, for example, until the acoustic signal and one or more other inputs are received. The other inputs may include, for example, a contact with a touch screen in a random or predefined manner, moving the mobile device from a state of rest in a random or predefined manner, pressing a button, and the like.

Some embodiments may include a wakeup mode 420. In response, for example, to the acoustic signal and other inputs, the mobile device 110 can enter the wakeup mode. In operation, the wake up mode can determine whether the (optionally recorded or buffered) acoustic signal includes one or more spoken commands. One or more stages of VAD can be used in the wakeup mode. The acoustic signal can be processed to suppress and/or cancel noise (for example, for noise robustness), and/or be processed for ASR. The spoken command(s), for example, can include a keyword selected by a user.

Various embodiments can include an authentication mode 430. In response, for example, to a determination that a spoken command was received, the mobile device can enter the authentication mode. In operation, the authentication mode determines and/or confirms the identity of a user (for example, speaker of the command) using the (optionally recorded or buffered) spoken command(s). Different strengths of consumer and enterprise authentication are used, including requesting and/or receiving other factors in addition to the spoken command(s). Other factors can include ownership factors, knowledge factors, and inherence factors. The other factors are provided via one or more of microphone(s), keyboard, touchscreen, mouse, gesture, biometric sensor, and the like. Factors provided through one or microphones are recorded or buffered, processed to suppress and/or cancel noise (for example, for noise robustness), and/or processed for ASR.

Some embodiments include a connect mode 440. In response to receipt of a voice command and/or a user being authenticated, the mobile device enters the connect mode. In operation, the connect mode performs an operation associated with the spoken command(s) and/or a subsequently spoken command(s). Acoustic signal(s) which contain at least one of the spoken command and/or subsequently spoken command(s) can be stored or buffered, processed to suppress and/or cancel noise (for example, for noise robustness), and/or be processed for ASR.

The spoken command(s) and/or subsequently spoken command(s) may control (e.g. configure, operate, etc.) the mobile device. For example, the spoken command may initiate communications via a cellular or mobile telephone network, VOIP (voice over Internet protocol), telephone calls over the internet, video, messaging (e.g., Short Message Service (SMS), Multimedia Messaging Service (MMS), and so forth), social media (e.g., post on a social networking or a service such as FACEBOOK or TWITTER), and the like.

In low power (for example, listen and/or sleep) modes, lower power may be provided as follows. An operation rate (for example, oversampled rate) of an analog to digital converter (ADC) or digital microphone (DMIC) can be substantially reduced during all or some portion of the low power mode(s), such that clocking power is reduced and adequate fidelity (to accomplish the signal processing required for that particular mode or stage) is provided. A filtering process, which is used to reduce oversampled data (for example, pulse density modulation (PDM) data) to an audio rate pulse code modulation (PCM) signal for processing, can be streamlined to reduce the required computational power consumption, again to provide sufficient fidelity at substantially reduced power consumption.

To provide higher fidelity signals in subsequent modes or stages (which may use higher fidelity signals than any of the earlier, lower power stages or modes), one or more of the oversampled rate, the PCM audio rate, and the filtering process can be changed. Any such changes are performed, with suitable techniques, such that the change(s) provides nearly seamless transitions. In addition or in the alternative, (original) PDM data may be stored in at least one of an original form, a compressed form, intermediate PCM rate form, and combinations thereof for later re-filtering with a higher fidelity filtering process or one that produces a different PCM audio rate.

The lower power modes or stages may operate at a lower frequency clock rate than subsequent modes or stages. A higher or lower frequency clock may be generated by dividing and/or multiplying an available system clock. In the transition to these modes, a phase-locked-loop (PLL) (or a delay-locked-loop (DLL)) is powered up and used to generate the appropriate clock. Using appropriate techniques, the clock frequency transition can be designed such that any audio stream has no significant glitches despite the clock transition.

The lower power modes can require use of fewer microphone inputs than other modes (stages). The additional microphones may be enabled when the later modes begin, or they can be operated in a very low power mode (or combinations thereof) during which their output is recorded in, for example, PDM, compressed PDM, or PCM audio format. The recorded data may be accessed for processing by the later modes.

In some embodiments, one type of microphone, such as a Digital Microphone, is used for the lower power modes. One or more microphones of a different technology or interface, such as an analog microphone converted by a conventional ADC, are used for later (higher power) modes which some types of noise suppression may be performed in. A known and consistent phase relationship between all the microphones is required in some embodiments. This can be accomplished by several means, depending on the types of microphones and ancillary circuitry. In some embodiments, the phase relationship is established by creating appropriate start-up conditions for the various microphones and circuitry. In addition or in the alternative, the sampling time of one or more representative audio samples can be time-stamped or otherwise measured. At least one of sample rate tracking, asynchronous sample rate conversion (ASRC), and phase shifting technologies may be used to determine and/or adjust the phase relationships of the distinct audio streams.

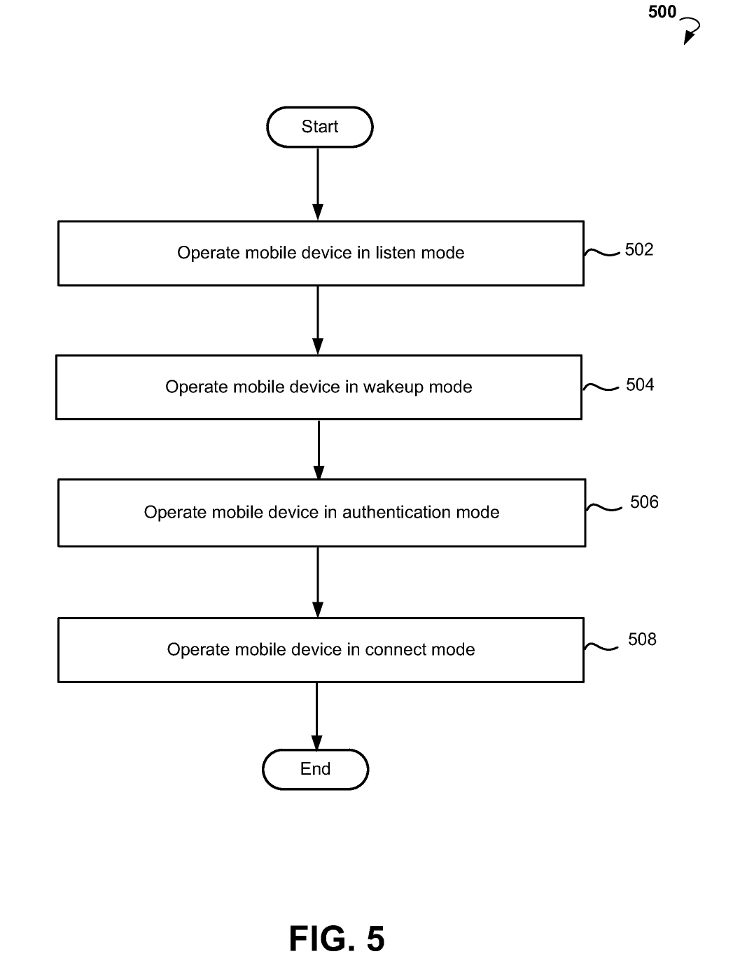

FIG. 5 is flow chart diagram showing steps of method 500 for voice-controlled communication connections, according to an example embodiment. The steps of the example method 500 can be carried out using the mobile device 110 shown in FIG. 2. The method 500 may commence in step 502 with operating mobile device in a listen mode. In step 504, the method 500 continues with operating mobile device in a wakeup mode. In step 506, the method 500 proceeds with operating mobile device in an authentication mode. In step 508, the method 500 concludes with the operating mobile device in a connect mode.

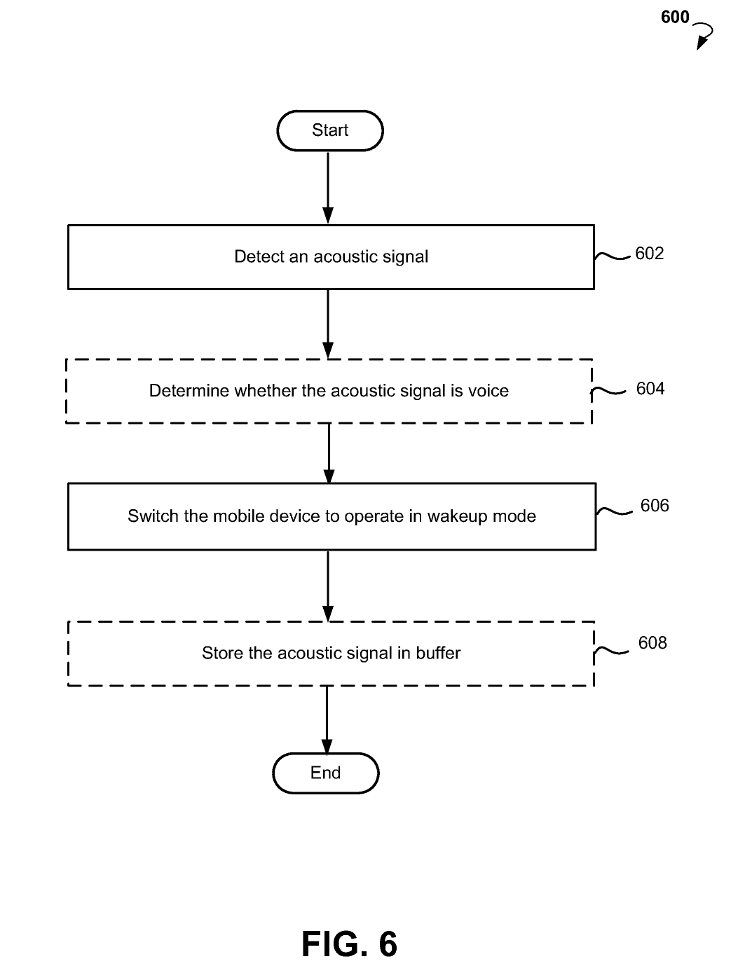

FIG. 6 shows steps of an example method 600 for operating a mobile device in a sleep mode. The method 600 provides details of step 502 of method 500 for voice-controlled communication connections shown in FIG. 5. The method 600 may commence with detecting an acoustic signal in step 602. In step 604, the method 600 can continue with (optional) determination as to whether the acoustic signal is a voice. In step 606, in response to the detection or determination, the method 600 proceeds with switching the mobile device to operate in the wakeup mode. In optional step 608, the acoustic signal can be stored in a sound buffer.

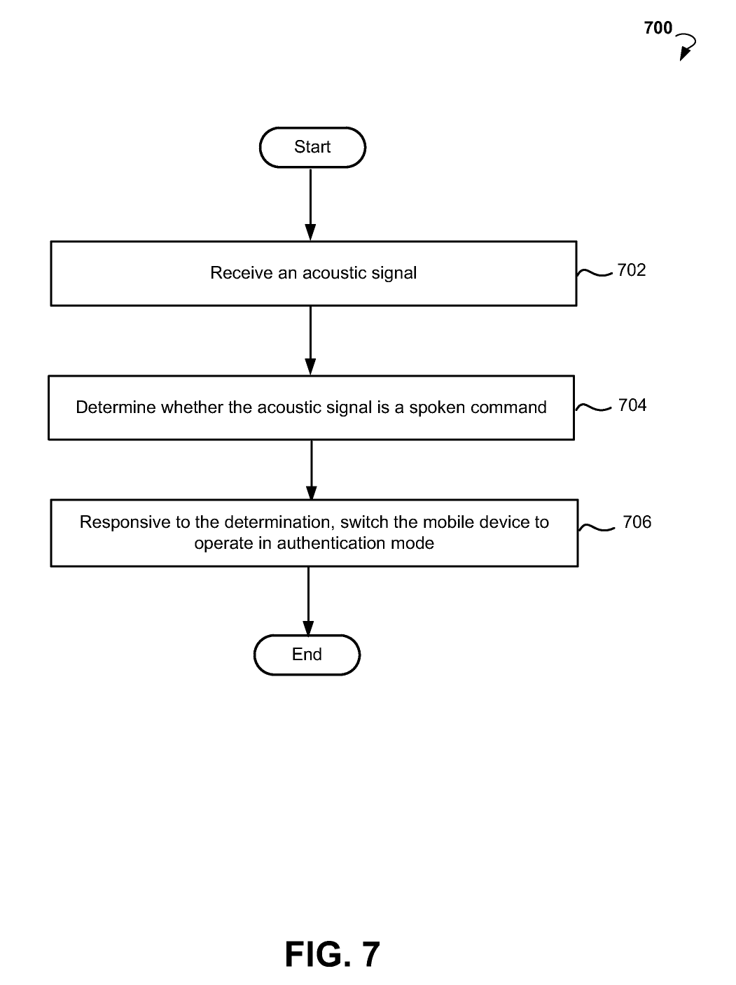

FIG. 7 illustrates steps of an example method 700 for operating a mobile device in a wakeup mode. The method 700 provides details of step 504 of method 500 for voice-controlled communication connections shown in FIG. 5. The method 700 may commence with receiving an acoustic signal in step 702. In step 704, the method 700 continues with determining whether the acoustic signal is a spoken command. In step 706, in response to the determination in step 704, the method 700 can proceed with switching the mobile device to operate in the authentication mode.

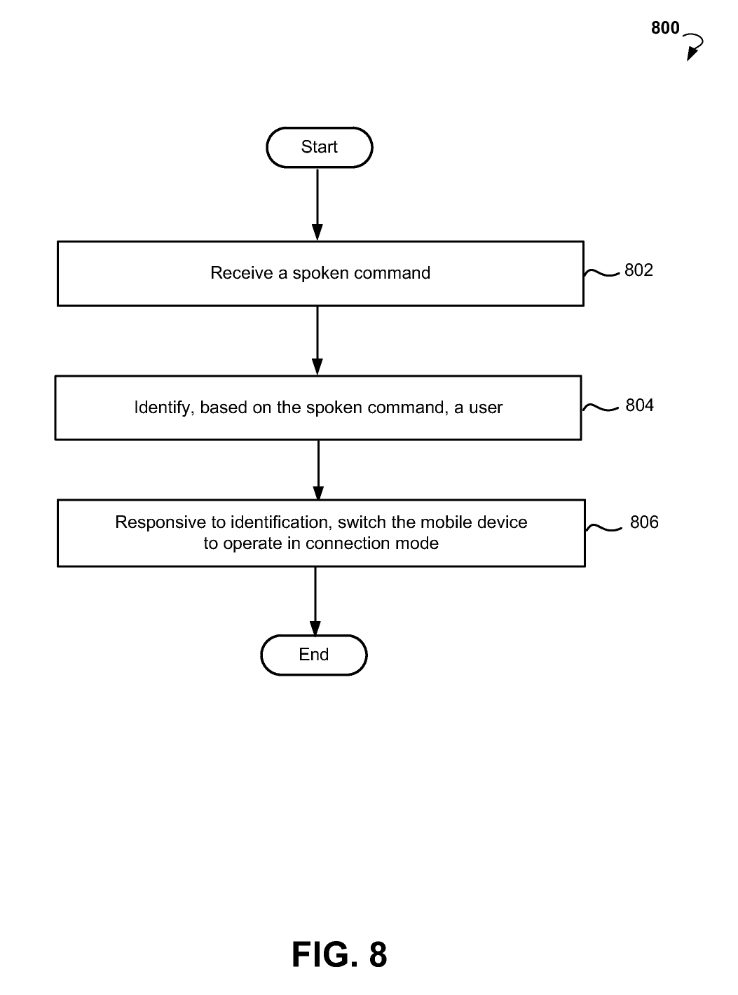

FIG. 8 shows steps of an example method 800 for operating a mobile device in an authentication mode. The method 800 provides details of step 506 of method 500 for voice-controlled communication connections shown in FIG. 5. The method 800 may commence with receiving a spoken command in step 802. In step 804, the method 800 continues with identifying, based on the spoken command, a user. In step 806, in response to the identification in step 804, the method 800 can proceed with switching the mobile device to operate in the connect mode.

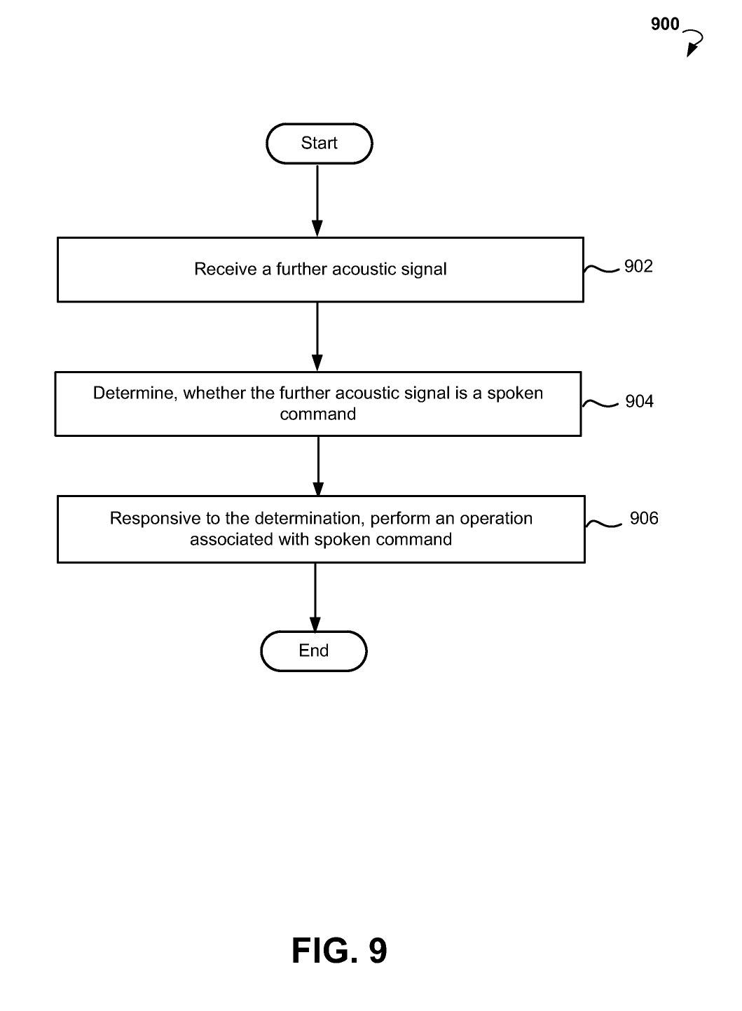

FIG. 9 shows steps of an example method 900 for operating a mobile device in a connect mode. The method 900 provides details of step 508 of method 500 for voice-controlled communication connections shown in FIG. 5. The method 900 may commence with receiving a further acoustic signal in step 902. In step 904, the method 900 continues with determining whether the further acoustic signal is a spoken command. In step 906, in response to the determination in step 904, the method 900 can proceed with performing an operation of the mobile device, the operation being associated with the spoken command.

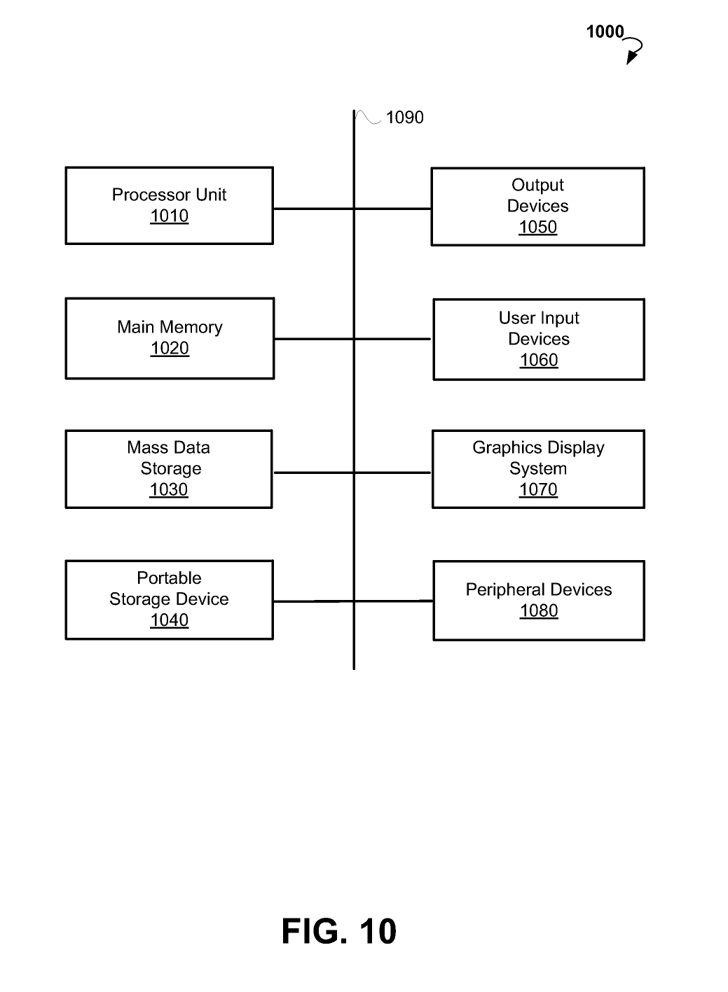

FIG. 10 illustrates an example computing system 1000 that may be used to implement embodiments of the present disclosure. The system 1000 of FIG. 10 can be implemented in the contexts of the likes of computing systems, networks, servers, or combinations thereof. The computing system 1000 of FIG. 10 includes one or more processor units 1010 and main memory 1020. Main memory 1020 stores, in part, instructions and data for execution by processor unit 1010. Main memory 1020 stores the executable code when in operation. The system 1000 of FIG. 10 further includes a mass data storage 1030, portable storage device 1040, output devices 1050, user input devices 1060, a graphics display system 1070, and peripheral devices 1080.

The components shown in FIG. 10 are depicted as being connected via a single bus 1090. The components may be connected through one or more data transport means. Processor unit 1010 and main memory 1020 may be connected via a local microprocessor bus, and the mass data storage device 1030, peripheral device(s) 1080, portable storage device 1040, and graphics display system 1070 may be connected via one or more input/output (I/O) buses.

Mass data storage 1030, which can be implemented with a magnetic disk drive, solid state drive, or an optical disk drive, is a non-volatile storage device for storing data and instructions for use by processor unit 1010. Mass data storage 1030 stores the system software for implementing embodiments of the present disclosure for purposes of loading that software into main memory 1020.

Portable storage device 1040 operates in conjunction with a portable non-volatile storage medium, such as a floppy disk, compact disk, digital video disc, or Universal Serial Bus (USB) storage device, to input and output data and code to and from the computer system 1000 of FIG. 10. The system software for implementing embodiments of the present disclosure may be stored on such a portable medium and input to the computer system 1000 via the portable storage device 1040.

User input devices 1060 provide a portion of a user interface. User input devices 1060 include one or more microphones, an alphanumeric keypad, such as a keyboard, for inputting alphanumeric and other information, or a pointing device, such as a mouse, a trackball, stylus, or cursor direction keys. User input devices 1060 can also include a touchscreen. Additionally, the system 1000 as shown in FIG. 10 includes output devices 1050. Suitable output devices include speakers, printers, network interfaces, monitors, and touch screens.

Graphics display system 1070 include a liquid crystal display (LCD) or other suitable display device. Graphics display system 1070 receives textual and graphical information and processes the information for output to the display device.

Peripheral devices 1080 may include any type of computer support device to add additional functionality to the computer system.

The components provided in the computer system 1000 of FIG. 10 are those typically found in computer systems that may be suitable for use with embodiments of the present disclosure and are intended to represent a broad category of such computer components that are well known in the art. Thus, the computer system 1000 of FIG. 10 can be a personal computer (PC), hand held computing system, telephone, mobile computing system, remote control, smart phone, tablet, phablet, workstation, server, minicomputer, mainframe computer, or any other computing system. The computer may also include different bus configurations, networked platforms, multi-processor platforms, and the like. Various operating systems may be used including UNIX, LINUX, WINDOWS, MAC OS, PALM OS, ANDROID, IOS, QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

Thus systems and methods for voice-controlled communication connections have been disclosed. The present disclosure is described above with reference to example embodiments. Therefore, other variations upon the example embodiments are intended to be covered by the present disclosure.

What is claimed is:

1. A method for voice-controlled communication connections, the method comprising:
operating a mobile device in a first mode, wherein the mobile device comprises one or more microphones and a memory;
operating the mobile device in a second mode;
operating the mobile device in a third mode; and
operating the mobile device in a fourth mode.

2. The method of claim 1 further comprising while operating the mobile device in the first mode:
detecting, via the one or more microphones, an acoustic signal;
determining whether the acoustic signal includes a voice;
based on the determination, switching the mobile device to the second mode; and
storing the acoustic signal in the memory of the mobile device or in a cloud-based memory.

3. The method of claim 1 further comprising, while operating the mobile device in the second mode:
receiving an acoustic signal;
determining whether the acoustic signal includes one or more spoken commands; and
based on the determination, switching the mobile device to the third mode.

4. The method of claim 3, wherein the acoustic signal is received via the one or more microphones.

5. The method of claim 3, wherein the acoustic signal is received from the memory.

6. The method of claim 3, wherein the one or more spoken commands includes a keyword selected by a user.

7. The method of claim 3 further comprising, while operating the mobile device in the third mode:
receiving the one or more spoken commands;
identifying, based on the one or more spoken commands, a user; and
based on the identification, switching the mobile device to the fourth mode.

8. The method of claim 1 further comprising, while operating the mobile device in the fourth mode:
receiving a further acoustic signal;
determining whether the further acoustic signal includes one or more further spoken commands; and
performing an operation of the mobile device, the operation being associated with the one or more further spoken commands.

9. The method of claim 1, wherein:
while being operated in the first mode, the mobile device is configured to consume less power than while being operated in the second mode;
while being operated in the second mode, the mobile device is configured to consume less power than while being operated in the third mode; and
while being operated in the third mode, the mobile device is configured to consume less power than while being operated in the fourth mode.

10. The method of claim 9, wherein, while being operated in first mode, the mobile device is configured to consume power less than 5 milliwatts.

11. The method of claim 1, wherein the one or more microphones comprises at least a first type microphone and a second type microphone and wherein a consistent phase relation is established between the first type microphone and the second type microphone.

12. The method of claim 1, wherein:
while being operated in a lower power mode, the mobile device is configured to provide for operation of a first type microphone selected from the one or more microphones, the lower power mode including one of the following: the first mode, the second mode, and the third mode; and
while being operated in a higher power mode, the mobile device is configured to provide for operation of a second type microphone selected from the one or more microphones, the higher power mode being different from the lower power mode and including one of the following: the second mode, the third mode, and the fourth mode.

13. A system for voice-controlled communication connections, the system comprising a mobile device, the mobile device comprising at least:
one or more microphones; and
a buffer; and
wherein the mobile device is configured for operating: in a first mode, in a second mode, in a third mode, and in a fourth mode.

14. The system of claim 13, wherein, while operating in the first mode the mobile the mobile device is configured to:
detect, via one or more microphones, an acoustic signal;
determine whether the acoustic signal includes a voice;
based on the determination, switch to operating in the second mode; and
store the acoustic signal in the buffer.

15. The system of claim 13, wherein, while operating in the second mode, the mobile device is configured to:
receive an acoustic signal;
determine whether the acoustic signal includes one or more spoken commands; and
based on the determination, switch to operating in the third mode.

16. The system of claim 15, wherein the acoustic signal is received via the one or more microphones.

17. The system of claim 15, wherein the acoustic signal is received from the buffer.

18. The system of claim 15, wherein the one or more spoken commands includes a keyword selected by a user.

19. The system of claim 15 wherein while operating in the third mode, the mobile device is configured to:
receive the one or more spoken commands;
identify, based on the one or more spoken commands, a user; and
based on the identification, switch to operating in the fourth mode.

20. The system of claim 13, wherein while operating in the fourth mode, the mobile device is configured to:
receive a further acoustic signal;
determine whether the further acoustic signal includes one or more further spoken commands; and
perform an operation of the mobile device, the operation being associated with the one or more further spoken commands.

21. The system of claim 13, wherein:
while operating in the first mode, the mobile device is configured to consume less power than while operating in the second mode;
while operating in the second mode, the mobile device is configured to consume less power than while operating in the third mode; and
while operating in the third mode, the mobile device is configured to consume less power than while operating in the fourth mode.

22. The system of claim 13, wherein the one or more microphones comprises at least a first type microphone and a second type microphone and wherein a consistent phase relation is established between the first type microphone and the second type microphone.

23. The system of claim 13, wherein:
while being operated in a lower power mode, the mobile device is configured to enable a first type microphone selected from the one or more microphones, the lower power mode including one of the following: the first mode, the second mode, and the third mode; and
while being operated in a higher power mode, the mobile device is configured to enable a second type microphone selected from the one or more microphones, the higher power mode being different from the lower power mode and including one of the following: the second mode, the third mode, and the fourth mode.

24. A non-transitory computer readable medium having embodied thereon a program, the program providing instructions for a method for voice-controlled communication connections, the method comprising:
operating a mobile device in a first mode, wherein the mobile device comprises:
one or more microphones;
a buffer; and
while operating the mobile device in the first mode:
detecting, via the one or more microphones, an acoustic signal;
determining whether the acoustic signal includes a voice;
based on the determination, switching the mobile device to a second mode; and
storing the acoustic signal in the buffer;
operating the mobile device in the second mode;
while operating the mobile device in the second mode:
receiving the acoustic signal;
determining whether the acoustic signal includes one or more spoken commands; and
based on the determination, switching the mobile device to a third mode;
operating the mobile device in the third mode;
while operating the mobile device in the third mode:
receiving the one or more spoken commands;
identifying based on the one or more spoken commands, a user; and
based on the identification, switching the mobile device to a fourth mode;
operating the mobile device in a fourth mode; and
while operating the mobile device in the third mode:
receiving a further acoustic signal;
determining whether the further acoustic signal includes one or more further spoken commands; and
performing an operation of the mobile device, the operation being associated with the one or more further spoken commands.

25. The non-transitory computer readable medium of claim 24, wherein while being operated in the first mode, the mobile device is configured to consume less power than while being operated in the second mode;
while being operated in the second mode, the mobile device is configured to consume less power than while being operated in the third mode;
while being operated in the third mode, the mobile device is configured to consume less power than while being operated in the fourth mode; and
while being operated in first mode, the mobile device is configured to consume power less than 5 milliwatts.
